(19) United States
(12) Patent Application Publication
(10) Pub. No.: US 2008/0249948 A1
(43) Pub. Date: Oct. 9, 2008

(54) FINANCIAL INFORMATION INPUT METHOD USING SYMMETRICAL KEY SECURITY ALGORITHM AND COMMERCIAL TRANSACTION SYSTEM FOR MOBILE COMMUNICATIONS

(76) Inventors: Chul Ki Kim, Songnam-city (KR); Que Min Hwang, Seoul (KR); Jung Hun Kim, Seoul (KR); Kwang Su Chang, Seoul (KR)

Correspondence Address: F. CHAU & ASSOCIATES, LLC, 130 WOODBURY ROAD, WOODBURY, NY, 11797, US

(21) Appl. No.: 12/146,992

(22) Filed: Jun. 26, 2008

Related U.S. Application Data
(62) Division of application No. 10/476,051, filed on Jun. 23, 2004.

(30) Foreign Application Priority Data
Apr. 25, 2001 (KR) 2001-22391

(51) Int. Cl. H04L 9/32; G06Q 20/00; G06Q 30/00

(52) U.S. Cl. 705/67; 705/71

(57) ABSTRACT

A financial information input method using a symmetric key security algorithm and a mobile communications commercial transaction system using the same encrypts financial information such as a customer's identification number and a valid date with a symmetric key algorithm by use of an electronic wallet administration number of a customer's terminal used as an encryption key at the time of applying an issuance of a card, and directly inputs the encrypted financial information into a customer's electronic wallet terminal or inputs the same via a communications network. In the case that a commercial transaction settlement is accomplished with a mobile communications terminal in which the encrypted financial information is stored, his or her own electronic wallet administration number is input so that the encrypted financial information and the administration number are optically transmitted to a POS terminal/card inquiry machine of an affiliated shop. The POS terminal/card inquiry machine which has received the encrypted financial information and administration number uses the received electronic wallet administration number and decodes the encrypted financial information with the administration number. Thus, although an unauthorized person knows an encryption algorithm unless a customer's electronic wallet administration number is exposed illegally, customer's financial information cannot be used. That is, an effect of fundamentally preventing customer's financial information from being illegally copied can be provided.

### CROSS-REFERENCE TO RELATED APPLICATIONS

This application is a divisional of application Ser. No. 10/476,051, filed Jun. 23, 2004, which claims priority to International Application No. PCT/KR02/00758, filed on Apr. 24, 2002 and Korean Patent Application No. 2001-22391, filed on Apr. 25, 2001, the disclosures of which are incorporated by reference herein in their entirety.

### TECHNICAL FIELD

The present invention relates to a commercial transaction system using a personal portable mobile communications terminal to which an optical transceiver is attached, and more particularly, to a financial information input method using a symmetrical key security algorithm in which financial information is encrypted through a symmetrical security algorithm so that the financial information cannot be illegally copied, and then the encrypted financial information is installed in a mobile communications terminal, and thus an expense of various transactions is settled through the mobile communications terminal.

### BACKGROUND ART

Recently, cards convenient to use and handy to carry compared with cash are widely being used. The cards are classified into a credit card, a cash card, a direct payment card, an advance payment card, a traffic card and so on according to a settlement method. The currently used cards are made in the form of a plastic or magnetic material. A magnetic recording surface on which card information such as a card identification number and a valid date is recorded exists on each of the cards.

By the way, since the above-described plastic or magnetic cards may be lost and unduly used, a new settlement system which uses a personal portable mobile communications terminal such as a portable phone or personal digital assistant (PDA) to which an optical transceiver is attached and which is always held by a user, has been proposed to be used as a substitute for the cards in order to process a settlement of payment. For example, there are Korean Patent Application No. 2000-13426 (not yet published) entitled “Commercial transaction system using mobile phone” and Korean Patent Application No. 2000-31640 (Laid-open publication No. 2001-112562 published on 20 Dec. 2001) entitled “Settlement method using mobile phone.” In these prior art Korean Patent Applications, an optical transceiver is attached to a portable mobile phone, an optical receiver is attached to a credit inquiry machine, and card information is stored in the mobile phone to which the optical transceiver is attached. Accordingly, optical transmission and reception is performed between the mobile phone and the credit inquiry machine, without using the credit cards, to thereby perform banking transactions.

By the way, in the case that a mobile communications terminal containing card information is used as a substitute for a magnetic card such as a credit card, an advance payment card, a banking settlement card and so on, the card information stored in the mobile communications terminal without any modification may be illegally copied and unduly used. In particular, in the case that card information is directly input into a memory in a mobile communications terminal, an expert who has a professional knowledge about the mobile communications terminal may illegally copy the mobile communications terminal memory using technical equipment. Thus, a card issuance authority such as a card company or a bank avoids card information from being stored in the mobile communications terminal in the same form as the information stored in a magnetic card. However, an encryption system using a personal asymmetric cryptosystem in banking transactions which are used by many and unspecified personas consumes much calculation time, which causes users to be inconvenienced and uncomfortable. Also, in the case that the symmetric keys are used, since symmetric keys input to a number of POS terminals are same, it is much difficult to protect keys. Also, a public key algorithm (PKI) is used to perform financial transactions in the case that a wireless Internet is used. However, even in this case, a private key is installed in a terminal, which makes it difficult to protect the key. Also, since the PKI requires much calculation time, it may not be easily applied to a small-sized terminal. However, if the PKI is applied to the small-sized terminal, it makes users inconvenienced by the much calculation time.

Accordingly, as an existing technology for increasing a security in banking transactions, Korean Patent Application No. 2001-16853 (not yet published) entitled “Method and system for storing financial settlement information in mobile communications terminal to settle payments” was proposed by the same inventor as that of the present application. Here, an electronic wallet administration number designated by a user at the time of applying a card issuance, is used as a symmetric key of an encryption algorithm, to encrypt financial information including a user's card identification number. The encrypted financial information is stored in the mobile communications terminal, to then decode the financial information and perform a settlement with the decoded financial information, by using the electronic wallet administration number during performing transactions.

### DISCLOSURE OF THE INVENTION

To solve the above problems, it is an object of the present invention to provide a method enhancing a financial transaction security in which financial information is encrypted using a symmetric security algorithm and the encrypted financial information is stored in a mobile communications terminal.

It is another object of the present invention to provide a mobile communications commercial transaction system for paying for an expense and settling the expense payment, via a mobile communications terminal in which financial information is stored by a financial information input method using a symmetric security algorithm.

To accomplish the above object of the present invention, there is provided a financial information input method using a symmetric security algorithm via a personal portable mobile communications terminal to which an optical transceiver is attached, the financial information input method comprising the steps of: (a) receiving declarative sentence financial information including a customer's number and a valid date of an issued card, and information obtained by encrypting the declarative sentence financial information on its own; (b) receiving an electronic wallet administration number and a telephone number of the mobile communications terminal at the time of application of a card issuance; (c) encrypting the declarative sentence financial information, by using the input customer's electronic wallet administration number as a symmetric key, and encrypting the encrypted financial information and the input telephone number again; and (d) storing the encrypted financial information and telephone number in the mobile communications terminal.

To accomplish the above object of the present invention, there is also provided a mobile communications commercial transaction system for settling an expense payment via a personal portable mobile communications terminal to which an optical transceiver is attached which is used for a substitute of a card, the commercial transaction system comprising: a mobile communications terminal receiving and storing encrypted financial information, encrypting an input electronic wallet administration number and stored financial information and telephone number at a settlement mode, by using a one-time pad (OTP) key as a symmetric key, and optically transmitting the encrypted electronic wallet administration number, financial information, and telephone number; a POS (Point Of Sales) terminal/card inquiry machine to which an optical transceiver is attached, for providing the OTP key at the time of an electronic wallet settlement via the mobile communications terminal, receiving and decoding the optically transmitted encrypted information, and requesting for settlement of the customer's transaction by using the decoded financial information; and a VAN (Value Added Network) company receiving the settlement request from the POS terminal/card inquiry machine, and notifying the POS terminal/card inquiry machine of an approval result.

### BRIEF DESCRIPTION OF THE DRAWINGS

The above objects and other advantages of the present invention will become more apparent by describing the preferred embodiments thereof in more detail with reference to the accompanying drawings in which:

FIG. 1 is a schematic view for explaining a financial information input method using a symmetric security algorithm according to an embodiment of the present invention;

FIG. 2 is a schematic view for explaining a financial information input method using a symmetric security algorithm according to another embodiment of the present invention;

FIG. 3 is a schematic view for explaining a financial information input method using a symmetric security algorithm according to still another embodiment of the present invention;

FIG. 4 is a schematic view showing a general commercial transaction system using a mobile communications terminal in which financial information is stored according to the present invention;

FIG. 5 is a schematic view showing a traffic transaction system according to the present invention;

FIG. 6 is a schematic view showing a vendor transaction system according to the present invention;

FIG. 7 is a schematic view showing an electronic commercial transaction system according to an embodiment of the present invention;

FIG. 8 is a schematic view showing an electronic commercial transaction system according to another embodiment of the present invention;

FIG. 9 is a schematic view showing an electronic commercial transaction system according to still another embodiment of the present invention;

FIG. 10 is a schematic view showing an entrance and exit security system according to the present invention; and

FIG. 11 is a schematic view showing a business card generating system according to the present invention.

### BEST MODE FOR CARRYING OUT THE INVENTION

Preferred embodiments of the present invention will be described in detail with reference to the accompanying drawings.

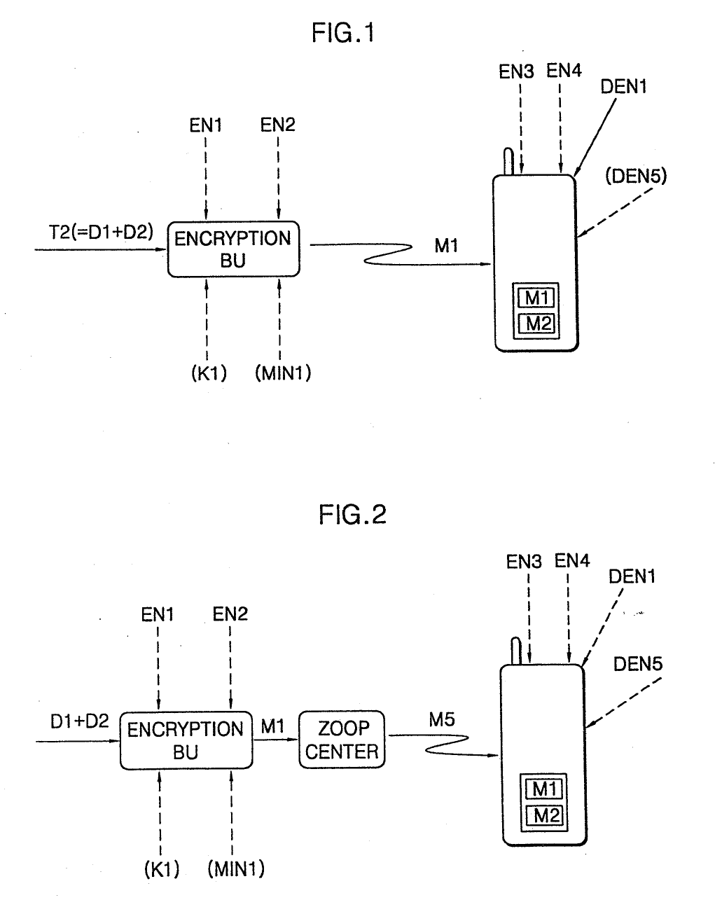

A financial information input method shown in FIG. 1 uses a symmetric security algorithm, in which the financial information is input into a portable phone by wire.

In FIG. 1, a financial authority such as a card company or a bank transmits information D1 including a customer's number and a valid date of a card to be issued to a card issuance applicant and information D2 obtained by encrypting the information D1 on its own, to a terminal for card issuance. Here, D1 is declarative information which is printed on a receipt in the financial authority, and D2 is information encrypted in the financial authority on its own. The card issuance terminal operates as an encryption base unit (BU) in which an optical transceiver module is mounted. The encryption base unit (BU) receives a secret number from a card issuance applicant, that is, a portable phone electronic wallet administration number K1 and a terminal phone number MIN1 for using a telephone number as a financial card. The encryption base unit (BU) executes encryption programs EN1 and EN2 by use of the electronic wallet administration number K1 as an encryption key and encrypts the input information (T2=D1+D2, MIN1). Here, the encryption program EN1 is a D1 encryption program which executes an encryption with the portable phone electronic wallet administration number K1, and the encryption program EN2 is a D2 and MIN1 encryption program which executes an encryption with the portable phone electronic wallet administration number K1. The encrypted information (M1=EN1(D1)+EN2(D2+MIN1)) is input into a portable phone by use of a lower-end jack of a portable phone or an optical transceiver. Here, in the case that financial information is input into a personal digital assistance (PDA) instead of a portable phone, a device identification number is encrypted and input in stead of the terminal phone number MIN1. That is, MIN means a telephone number or a terminal identification number (ESN). Meanwhile, a portable phone is used as a traffic card for payment of fare of traffic facility such as buses and subways. For this purpose, the portable phone uses a key Kt for a traffic mode to execute an encryption program EN3 and thus encrypts information D1 representing a customer's number and a valid date among the input information M1 to then store the encrypted information. Here, the encryption program EN3 is an encryption program for encrypting the D1 and a telephone number MIN2 stored in a terminal when a telephone call is performed to perform an encryption with a key Kt (M2=EN3(D1+MIN2). Thus, the encrypted financial information M1 and M2 is stored in the portable phone to use it for settlement of payment of expenses during commercial transactions.

FIG. 2 is a schematic view for explaining a financial information input method using a symmetric security algorithm according to another embodiment of the present invention, in which financial information is input into a portable phone wirelessly. The FIG. 2 system is realized in the same manner as the FIG. 1 system. In FIG. 2, a relay center called a zoop center is installed between an encryption base unit (BU) located at a financial authority terminal and a portable phone. The relay center receives the encrypted information (MI) from the encryption base unit (BU) of the financial authority terminal and executes an encryption program EN5, to encrypt the encrypted information M1 together with a terminal telephone number MIN1. The relay center wirelessly transmits the encrypted information (M5=EN5(M1+MIN1)) to then be inputted into the portable phone. That is, although the portable phone receives the encrypted information M1 directly from the encryption base unit (BU) of the financial authority terminal in FIG. 1, the portable phone receives the re-encrypted information through the relay center.

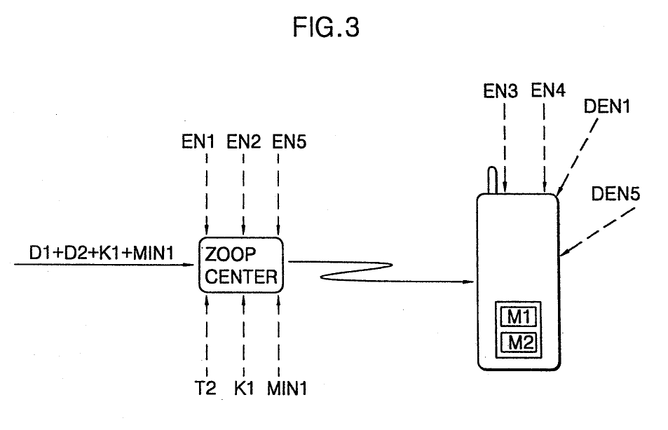

FIG. 3 is a schematic view for explaining a financial information input method using a symmetric security algorithm according to still another embodiment of the present invention, which illustrates another method for inputting financial information wirelessly into a portable phone. In FIG. 3, financial authority sends information D1 such as a customer's identification number and a valid date, information D2 encrypted in the financial authority, a customer's designated electronic wallet administration number K1 and a terminal telephone number MIN1 to a relay center. The relay center executes encryption programs EN1 and EN2 using the electronic wallet administration number K1 as a key, to produce encrypted financial information M1, and then inputs the encrypted information M1 to a portable phone wirelessly.

A settlement method using a portable phone to which the encrypted financial information is input as described above can be applied to various fields. For example, the settlement method using a portable phone having the encrypted financial information can be used in most payments of expenses of a general commerce, a traffic transaction such as a bus or subway, a vending machine, and an electronic commerce. Commercial systems using a mobile communications terminal having the encrypted financial information according to various embodiments will be described below in more detail.

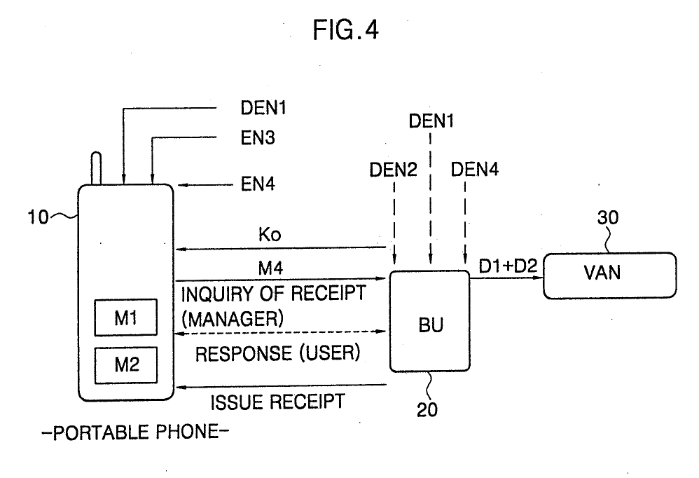

FIG. 4 is a schematic view showing a general commercial transaction system using a mobile communications terminal in which financial information is stored according to the present invention. The system shown in FIG. 4 includes a mobile communications terminal 10 to which an optical transceiver having encrypted financial information M1 and M2 therein is attached, a base unit (BU) 20 for use in a POS terminal or card inquiry machine which is installed in an affiliated shop for optically receiving the transmitted financial information and decoding the same, and a VAN company 30 requesting for an approval of transactions with respect to a corresponding financial authority, by use of the decoded financial information and transferring a transaction approval result. An operation of performing a settlement processing with respect to the encrypted financial information in the general commercial transaction system of FIG. 4 will be described below in more detail.

A customer selects a settlement mode by manipulation of a keypad in a mobile communications terminal 10. At a settlement mode, the customer selects the kind of a card to be used. The mobile communications terminal 10 encrypts declarative financial information D1 including a customer's identification number and a valid date with a customer's designated electronic wallet administration number K1. Basic financial information M1 obtained by encrypting information D2 encrypted by financial authority on its own and a terminal telephone number MIN1 with the electronic wallet administration number K1 is stored in the mobile communications terminal 10 in advance. If a customer selects a traffic card, the mobile communications terminal 10 executes a stored decoding program DEN1 to decrypt the encrypted financial information D1, and encrypts the financial information D1 and a telephone number MIN currently stored in the terminal, with an encryption algorithm EN3 to then be stored in a designated memory region. Here, a symmetric key is a telephone number MIN. Meanwhile, the mobile communications terminal 10 executes a stored encryption program EN4 to encrypt the stored basic financial information M1, the electronic wallet administration number K1 and the stored terminal telephone number MIN, in the case of general credit card transactions. Here, a symmetric key is a key Ko for a one-time pad provided from a base unit (BU) 20 for use in a POS terminal or card inquiry machine. The mobile communications terminal 10 sends the encrypted information M4 to the base unit (BU) 20 for use in a POS terminal or card inquiry machine. The base unit (BU) 20 for use in a POS terminal or card inquiry machine stores decoding programs DENI, DEN2 and DEN4 corresponding to the encryption programs stored in the mobile communications terminal 10. The base unit (BU) 20 for use in a POS terminal or card inquiry machine executes the stored decoding programs to decode the encrypted information M4 and transfer the financial information D1+D2 restored into an original state to the VAN company 30 as in a current financial transaction system, to perform a settlement process. The optical transceivers attached to the mobile communications terminal 10 and the base unit (BU) 20 for use in a POS terminal or card inquiry machine are bidirectional. Thus, if a program in the POS terminal or card inquiry machine is altered, the following new services can be provided.

After issuing a receipt, an affiliated shop inquires whether a customer wishes to receive a digital receipt. If the customer wishes to receive the digital receipt, a digital receipt issuance button on the POS terminal or card inquiry machine is manipulated. Here, the customer points the portable mobile communications terminal 10 to the optical transceiver in the base unit (BU) 20 for use in a POS terminal or card inquiry machine, to receive the digital receipt through the mobile communications terminal 10. The mobile communications terminal 10 stores the received digital receipt therein or displays it on a screen. It is also possible to issue a letter of invitation including a coupon for the purpose of management of customers, other than the digital receipt.

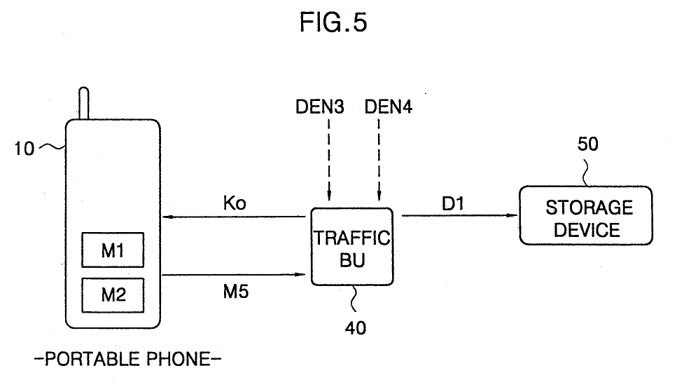

FIG. 5 is a schematic view showing a traffic transaction system using a mobile communications terminal storing financial information according to the present invention. The system shown in FIG. 5 includes a mobile communications terminal 10 having encrypted financial information M1 and encrypted traffic information M2 therein, a traffic base unit (BU) 40 which is installed in an entrance and/or exit gate of a bus or subway, or a highway toll gate, and having a decoding program, and a storage device 50 storing transaction details. An operation of performing a settlement process with respect to the encrypted financial information in the traffic transaction system of FIG. 5 will be described below in more detail.

In the case of a commercial transaction requiring a quick processing time such as in a traffic card, a customer pays a traffic fare using a mobile communications terminal 10. The mobile communications terminal 10 stores encrypted financial information M1 and encrypted traffic information M2 therein. Thus, the customer manipulates the terminal 10 to encrypt the stored encrypted traffic information M2 and terminal telephone number MIN, and a terminal internal time with an OTP, and sends the encrypted information (M5=EN4(M2+MIN+Time)) to a traffic base unit (BU) 40. Here, the mobile communications terminal (MU) 10 stores encryption programs EN3 and EN4 and the traffic BU stores decoding programs DEN3 and DEN4 respectively corresponding to the encryption programs EN3 and EN4. The traffic BU 40 decodes the OTP to calculate the card information M2, the telephone number MIN and a time. If a time is found abnormal, an approval of transactions is rejected. Meanwhile, if the former is found normal, a decoding program DEN3 is executed to decode the encrypted card information M2 and to calculate the financial information D1 and the telephone number MIN2. Here, the two telephone numbers MIN and MIN2 are compared. Thus, if both the telephone numbers are same, the encrypted information output from the traffic BU 40 is transmitted to a database for traffic control, and if both telephone numbers differ from each other, a traffic toll gate passage is not allowed and a disapproval of passage is displayed on a screen.

In a closed type section such as a subway or highway, an entrance time and a gate number which are received from the traffic BU 40 are recorded and stored in a memory of the mobile communications terminal 10 at an entrance gate. At an exit gate, the entrance gate information and the settlement information is transmitted together. The settlement process adopts an existing method which is stored in a database and performs a settlement operation all at a time, the detailed description of which will now be omitted.

Also, for the convenience of users, a traffic card issuance authority, for example, a card company can store the encrypted traffic information M2 together with the financial information M1 by wire or wirelessly.

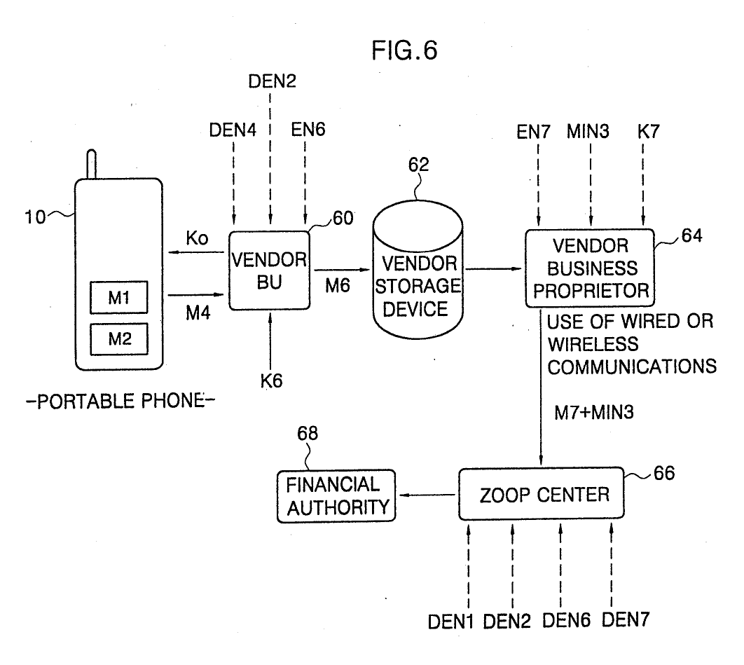

FIG. 6 illustrates a case that the present invention is applied to a transaction system in which an existing network is not formed as in a vending machine or bus according to the present invention. In these transactions, moneys such as coins or bills are used as payment currency and the moneys are collected in the conventional case. The present invention uses personal credit information, for substitution of the direct monetary payment and collection in the conventional cases. Here, an example of a vending machine will be described.

A vendor BU 60 to which an optical transceiver is attached stores decoding programs DEN2 and DEN4. Also, an encryption program EN6 storing financial information is stored in a storage device 62 of a vendor. The mobile communications terminal 10 stores encrypted financial information M1 and encrypted traffic information M2 therein. Thus, the terminal 10 encrypts the stored financial information M1, the terminal telephone number MIN, a customer's designated terminal electronic wallet administration number K1, and a terminal internal time with an OTP, and sends the encrypted information (M4=EN4(M1+K1+MIN)) to a vendor base unit (BU) 60. Here, the terminal 10 stores encryption programs EN3 and EN4. The vendor BU 60 decodes information M4 received from the terminal 10 by use of the OTP to calculate financial information M1, a telephone number MIN and an electronic wallet administration number K1. The vendor BU 60 uses the electronic wallet administration number K1 as a decoding key for the encrypted financial information M1, to decode the financial information M1 and then calculate a terminal telephone number MIN1 for allowing a financial authority 68 to use a customer's requested telephone number as a financial card. The vendor BU 60 compares both the telephone numbers MIN1 and MIN with each other. If both numbers are same, an approval of transactions is issued and transaction details M6 are stored in a storage device 62 in the vendor. Here, the transaction details M6 include a time, declarative financial information D1 including a customer's identification number and a valid date, information D2 encrypted by a financial authority, and a terminal telephone number MIN1 allowed as a financial card, which are encrypted by an encryption program EN6 for use in a vendor business proprietor. When a high level security is not necessary by negotiation with the financial authority 68, only partial information can be stored. A key K6 of the encryption program EN6 for the vendor business proprietor is encrypted with an optional key between the vendor business proprietor 64 and a settlement relay center 66 and the encrypted key is stored therein. The relay center 66 is an authority for relaying between the financial authority 68 and the vendor business proprietor 64. A mechanical device for altering the key K6 can be installed in the vendor. Also, the vendor business proprietor 64 can install the key K6 using a portable device such as a PDA and an optical transceiver attached to the vendor BU 60. The vendor business proprietor 64 takes out the vendor storage device 62 from the vendor and inserts a new storage device. Then, the vendor business proprietor 64 submits the taken-out storage device 62 to the relay center 66 to perform a settlement of transactions, or can collect the sales money directly on an IR or RF non-contact basis, in which case a separate collection device should be provided. The storage device 62 may be a disc-type memory or a flash ROM-type memory. In the case that it is far from the relay center 66, a storage device 62 for settlement in a vendor is inserted into a portable storage device such as a PDA having a function of communications which is an optional device with the relay center and information stored in the storage device is transmitted to the relay center 66 by use of wireless communications. In the wireless communications section, the information is re-encrypted with a key K7 which is optional with the relay center and the re-encrypted information is transmitted. The relay center 66 decodes the information by using a decoding program DEN7 for decoding the optional key K7 as a symmetric key and then obtains a telephone number MIN3 registered by the vendor business proprietor 64 in the relay center 66, to thereby ascertain whether the obtained telephone number MIN3 coincides with a currently connected telephone number and perform an authentication. Also, the relay center 66 uses a decoding program DEN6 to obtain financial information D1+D2+MIN1 and then performs a settlement with respect to the financial authority 68. In this case, a time with respect to a customer's transaction point in time is stored to prevent a double billing and payment, which increases a security of settlement.

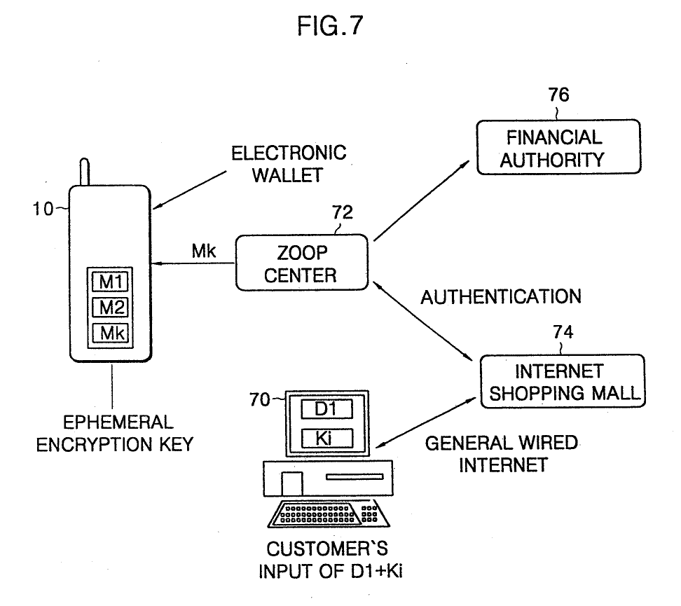

FIG. 7 is a schematic view showing an electronic commercial transaction system according to an embodiment of the present invention, which illustrates an electronic commerce on the Internet. The system shown in FIG. 7 includes a terminal 10 such as a portable phone or a PDA storing an ephemeral encryption key Mk in addition to financial information M1 and traffic information M2, a PC (personal computer) 70 which can be accessed to an Internet shopping mall 74 via a general wired Internet to perform an electronic commercial transaction, and a relay center (zoop center) 72 which connects among respective components to perform a settlement process. An operation of performing a settlement process with the financial information encrypted in the electronic commercial transaction system on the wired Internet of FIG. 7 will be described in more detail.

The relay center 72 sends an ephemeral encryption key K1 to an electronic wallet in a customer's terminal 10. Here, since a section between the relay center 72 and the electronic wallet terminal 10 is a wireless section, the electronic wallet administration number K1 is used as a symmetric key to encrypt the ephemeral encryption key K1 and transmit the encrypted ephemeral encryption key K1 for security. The encrypted key (Mk=EN 1(K1)) is automatically input to a customer's electronic wallet, which cannot be seen except for the authorized customer. That is, a settlement mode input administration number of an electronic wallet can be input by only a true authorized person. At the time of performing an electronic commercial transaction on the wired Internet, a customer selects a settlement with the ephemeral encryption key service during settling in the Internet shopping mall 74, enters an electronic wallet mode, and then selects a credit card information view. Then, a credit card number, a valid date and the ephemeral encryption key Ki are confirmed, and then are typed on the browser in the PC 70 at the time of using an existing infrastructure. The Internet shopping mall 74 sends the card number, the valid date and the ephemeral encryption key Ki which have been received from the customer's PC 70 to the relay center 72 to request for authentication. The relay center 72 confirms the customer's credit card number and the encryption key and performs an authentication according to the confirmed result. If there is no abnormality in the result of the authentication, an approval is requested for with respect to a financial authority 76. Thereafter, a new encryption key is transmitted to the customer's terminal 10. That is, a security can be heightened while the current system is being used as it is.

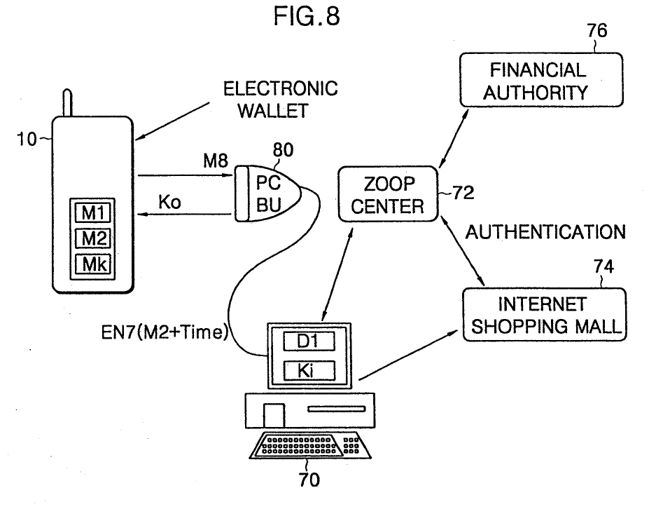

FIG. 8 is a schematic view showing an electronic commercial transaction system according to another embodiment of the present invention, which illustrates an electronic commerce on a wired Internet in the case that an optical transmission and reception module is attached to a customer's PC.

In FIG. 8, a customer points a mobile communications terminal 10 such as a portable phone or a PDA to a PC base unit (BU) 80 which is an optical transmission and reception module. Then, financial information M2 and a time stored in the terminal 10 are encrypted with an ephemeral encryption key Ki and the encrypted information is transmitted. Here, a declarative telephone number MIN is transmitted together with the encrypted information. The PC BU 80 transmits information M8 transmitted from the electronic wallet of the customer's terminal 10 to a relay center 72 via a PC 70. The relay center 72 ascertains the encryption key with the customer's telephone number MIN and decodes the encryption key using the customer's telephone number. When there is no abnormality in the time, the financial information M2 is decoded and the stored two telephone numbers MIN and MIN2 are compared with each other, to perform an authentication again. Then, if there is no abnormality in the result of the re-authentication, an approval is requested for with respect to a financial authority 76. Thereafter, an ephemeral encryption key Mk obtained by encrypting a new encryption key Ki is transmitted to the customer's terminal 10. That is, a security can be heightened while the current system is being used as it is.

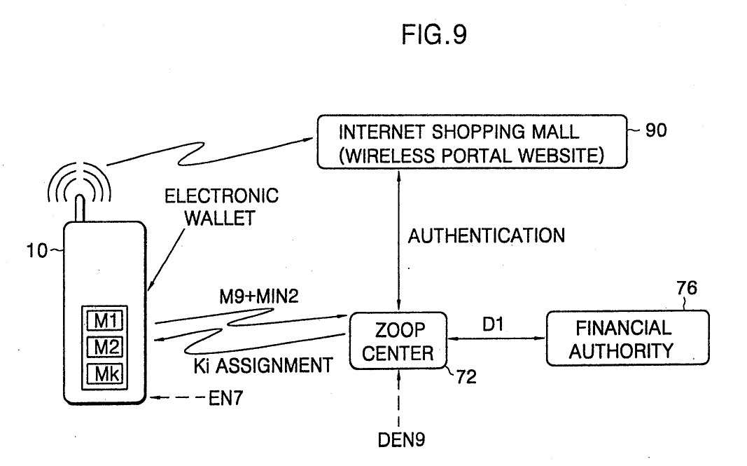

FIG. 9 is a schematic view showing an electronic commercial transaction system according to still another embodiment of the present invention, which illustrates an electronic commercial transaction on the wireless Internet.

In FIG. 9, in the case of an electronic commercial transaction on the wireless Internet, a relay center 72 encrypts an ephemeral encryption key Ki and transmits the encrypted ephemeral encryption key Ki to an electronic wallet of a customer's terminal 10 in advance, like an electronic commercial transaction on the wired Internet. The encrypted ephemeral encryption key Mk is automatically input to the customer's electronic wallet and cannot be seen by an unauthorized person. That is, a settlement mode input administration number of an electronic wallet can be input by only a true authorized person. At the time of performing an electronic commercial transaction on the wireless Internet, a customer selects a “relay center settlement (zoop settlement)” during settling in the wireless Internet shopping mall 90. Then, the customer's terminal 10 is wirelessly connected to the relay center 72 to request for an approval of transaction. Financial information M2 and a time stored in the customer's terminal 10 are encrypted with an ephemeral encryption key Ki and the encrypted information is transmitted to the relay center 72. In this case, a terminal declarative telephone number MIN is transmitted together with the encrypted information. The relay center 72 ascertains the encryption key with a customer's telephone number MIN and decodes the encryption key using the customer's telephone number MIN.

The ephemeral encryption key Ki cannot be decoded unless a customer remembers a correct electronic wallet administration number K1, and an accurate encryption is performed by using the decoded ephemeral encryption key. Thus, a security is further enhanced. When there is no abnormality in the time, the financial information M2 is decoded and the stored telephone number MIN2 and the input telephone number MIN are compared with each other, to perform an authentication again. Then, if there is no abnormality in the result of the re-authentication, an approval is requested for with respect to a financial authority 76. For convenience, a time comparison can be omitted depending upon an importance of a security.

That is, the information stored in the terminal 10 and the information treated in the wireless transmission section is always encrypted and transformed. Accordingly, illegal copies and undue use of information by an unauthorized person can be prevented fundamentally. Also, a game stored in the PC 72 can be downloaded to the mobile communications terminal 10 through an optical transceiver which is attached to the mobile communications terminal 10. Thus, with this function, users can enjoy games via the mobile communications terminal 10 such as a portable phone without having a separate game machine.

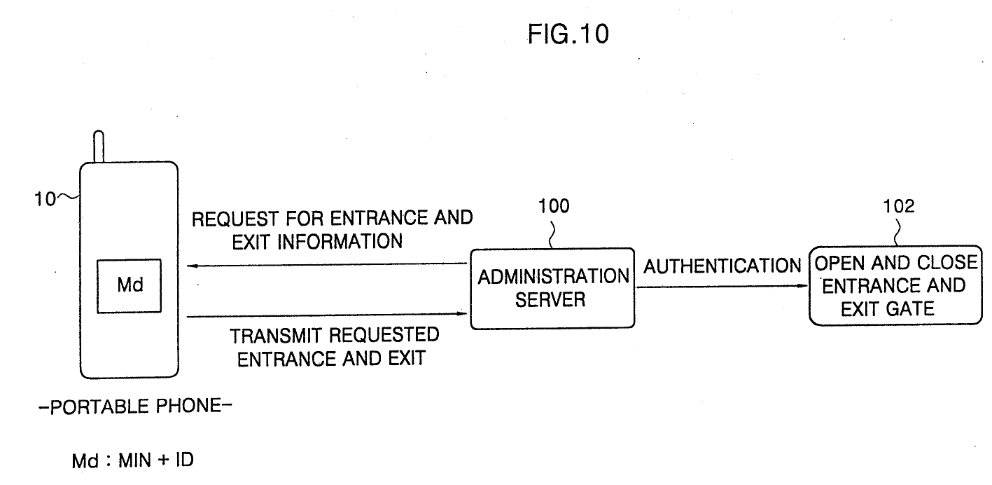

FIG. 10 is a schematic view showing an entrance and exit security system according to the present invention. An entrance and exit administration authority assigns an entrance and exit security related identification (ID) to a portable device such as a portable phone, and inputs the assigned ID into an electronic wallet of a customer's terminal 10 which is the portable device. The terminal 10 stores the assigned ID together with a telephone number MIN as entrance and exit security related information Md. A customer presses a key which is used for a traffic on a keypad in the terminal 10 upon request of entrance and exit information from an entrance and exit administration server 100, and transmits the stored entrance and exit information Md. The entrance and exit administration server 100 compares the entrance and exit information Md transmitted from the customer's terminal 10 with a previously registered telephone number and the ID, and controls entrance and exit according to the result of comparison. Only a telephone number may be registered and used at a place where a heavy security is not necessary. However, an ID input may be input by using a particular module at a place where a reinforced security is needed.

Even in the case that a variety of entrance and exit security information exists, an ID code number for a base unit having an optical transceiver in an entrance and exit administration server can be designated. Accordingly, since the designated ID can be taken among various IDs, a customer can open and close an entrance and exit gate with only a one-time point and shoot of his or her own terminal, which further provides a convenience to the customers.

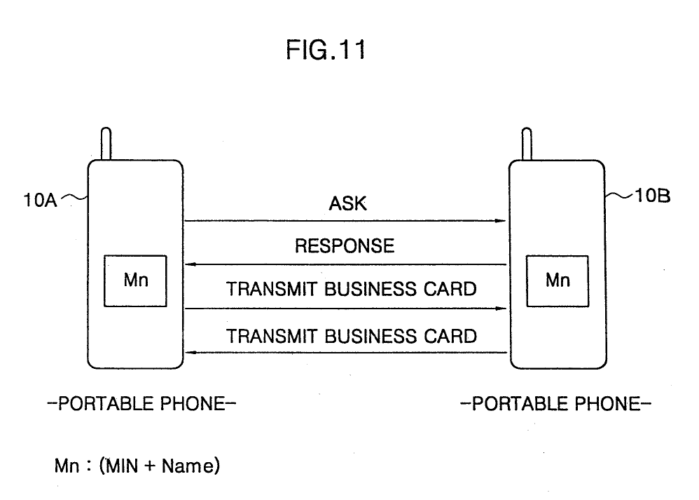

FIG. 11 is a schematic view showing a business card generating system according to the present invention. Business card information Mn including a telephone number MIN and a name is recorded in portable devices 10A and 10B. Then, a business card can be exchanged with each other between the portable devices 10A and 10B. For exchange of business cards, portable devices 10A and 10B are made to face each other, and point to each other. The recorded business card information can be exchanged between the facing portable devices 10A and 10B by pressure of buttons. Since devices which are connected in the first place with each other among a number of devices communicate with each other on a one-to-one communications basis, this function can provide an effect of conveniently mating persons who participate in the meeting.

As described above, the financial information input method and the mobile communications commercial transaction system using a symmetric key security algorithm according to the present invention, inputs financial information encrypted with a symmetric key which differs by each customer into a mobile communications terminal to which an optical transceiver is attached, and thus uses the mobile communications terminal for a substitute of a magnetic or plastic card. Accordingly, the present invention provides an effect of conveniently performing all settlements with the mobile communications terminal without possessing a wallet separately, and playing a role of an electronic wallet storing information of various cards and financial information at the same time. Also, card companies have advantages of increasing conveniences of customers and enhancing securities without altering the existing system, to accordingly maximizing profits. Also, in the case that a customer's card number and a valid date should be typed as in an existing Internet settlement requiring such inputs on the browser, the card information can be displayed as a card information confirmation menu on a screen in the mobile communications terminal, and the selected card information can be used as in the existing card settlement. Also, the present invention can perform commercial transactions by using an ephemeral encryption key even on a wireless Internet under the existing infrastructure. Also, a customer presses a button only one-time to perform all encryption authentications without a complicated customer authentication during a wireless Internet commercial transaction, to thereby provide an advantage of increasing a security without damaging conveniences of customers. Also, since stored information always differs from transmitted information on the wired or wireless Internet, illegal copies of the information cannot be used to thereby enhance a safety of transactions.

The present invention is not limited in the above-described embodiments. It is apparent to one who is skilled in the art that there are many variations and modifications without departing off the spirit of the present invention and the scope of the appended claims.

### INDUSTRIAL APPLICABILITY

As described above, a method for storing financial settlement information in a mobile communications terminal and performing a settlement and a system using the same according to the present invention can be used in a financial settlement card field where a settlement is accomplished in the form of a credit card, a direct payment card, a cash card, a department store card, an electronic money, a gift certificate, a coupon and so on, and an identification (ID) card field where a personal identification is accomplished in the form of a healthy insurance card, an entrance and exit passage certificate storing personal ID information and a bonus card and a family card capable of receiving various additional services through ID confirmation.

1. A traffic transaction system for settling a traffic fare via a personal portable mobile communications terminal to which an optical transceiver is attached which is used as a traffic card, the traffic transaction system comprising:
a mobile communications terminal storing encrypted financial information and decoding programs, re-encrypting the stored information, the telephone number and an internal time if a customer selects a traffic card usage at a settlement mode, by using a one-time pad (OTP) key as a symmetric key, and optically transmitting the re-encrypted result;
a traffic base unit (BU) to which an optical transceiver is attached, for providing the OTP key to the mobile communications terminal, receiving and decoding the optically transmitted encrypted information, to calculate the financial information, the telephone number and the time, decoding the financial information again to calculate the financial information and telephone number of an original state, and comparing the calculated two telephone numbers and determining whether an approval of transactions is allowed according to the result of comparison; and
a storage device for collecting and storing the transaction details approved by the traffic base unit (BU) to settle the transactions by bulk.

2. The traffic transaction system of claim 1, wherein said mobile communications terminal stores the decoding programs and decodes the encrypted financial information, to obtain declarative financial information including a card customer's identification number and valid date, and re-encrypts the obtained financial information with a stored terminal telephone number used as a symmetric key and stores the re-encrypted financial information as traffic card information.

3. The traffic transaction system of claim 1, wherein said mobile communications terminal directly receives and stores the encrypted traffic card information from an issuance authority by wire or wirelessly.

4. The traffic transaction system of claim 2, wherein said mobile communications terminal encrypts the stored traffic card information together with a terminal telephone number and a time if a customer selects a traffic card at a settlement mode, and optically transmits the encrypted result to the traffic base unit (BU).

5. The traffic transaction system of claim 4, wherein said traffic base unit (BU) stores the decoding programs and decodes the optically transmitted encrypted information to calculate the traffic card information, the terminal telephone number and the time, decodes the traffic card information with the customer's telephone number used as a symmetric key when there is no abnormality in the calculated time, to calculate the financial information and the terminal telephone number, and compares the two calculated telephone numbers and approves the transactions when the two telephone numbers are same.

6. The traffic transaction system of claim 5, wherein said traffic base unit (BU) optically transmits an entrance time and entrance information to the mobile communications terminal at an entrance gate to be stored in the mobile communications terminal, and receives the information from the mobile communications terminal to settle the traffic fare at an exit gate, when the traffic transaction system is installed in a closed section including a subway, a highway, and so on.

7. An electronic commercial transaction system comprising:
a mobile communications terminal storing encrypted financial information, for selecting an Internet electronic commercial transaction settlement with an input ephemeral encryption key, to thereby provide financial information which can be seen by an authorized customer;
a personal computer (PC) for performing an electronic commercial transaction in an Internet shopping mall through connection with the Internet, inputting the financial information and ephemeral encryption key provided from the mobile communications terminal onto a browser screen to request for a settlement of payment;
the Internet shopping mall for transmitting the financial information and the ephemeral encryption key input from the Internet connected PC to a relay center to thereby request for an authentication;
and the relay center for transmitting a new ephemeral encryption key to the mobile communications terminal whenever an approval of transaction is accomplished, and confirming the authentication requested financial information and encryption key to perform an authentication.

8. The electronic commercial transaction system of claim 7, wherein said relay center encrypts the ephemeral encryption key with a terminal electronic wallet administration number used as a symmetric key, and wirelessly transmits the encrypted result to the mobile communications terminal.

9. The electronic commercial transaction system of claim 7, wherein said PC comprises an attached optical transmission and reception module, and said mobile communications terminal encrypts the stored financial information and time with an ephemeral encryption key, and transmits the encrypted ephemeral encryption key together with the declarative terminal telephone number toward the PC optical transmission and reception module.

10. The electronic commercial transaction system of claim 9, wherein said PC receives the optically transmitted information and transmits the same to the relay center.

11. The electronic commercial transaction system of claim 7, wherein said mobile communications terminal is connected to a shopping mall by the wireless Internet to perform an electronic commercial transaction, encrypts the stored financial information and the time with an ephemeral encryption key during settlement, and transmits the encrypted result together with the declarative terminal telephone number to the relay center.

12. The electronic commercial transaction system of claim 10, wherein said relay center confirms an encryption key with the declarative terminal telephone number among the transmitted information, decodes the encrypted financial information with the confirmed encryption key used as a symmetric key, disapproves the transactions if the restored time is not a current time, decodes the financial information if the former is the latter, and compares the stored telephone number with the received telephone number (MIN), to thereby perform an authentication again.

13. The electronic commercial transaction system of claim 11, wherein said relay center confirms an encryption key with the declarative terminal telephone number among the transmitted information, decodes the encrypted financial information with the confirmed encryption key used as a symmetric key, disapproves the transactions if the restored time is not a current time, decodes the financial information if the former is the latter, and compares the stored telephone number with the received telephone number (MIN), to thereby perform an authentication again.

14. The electronic commercial transaction system of claim 9, wherein said PC stores games, makes the games downloaded to the mobile communications terminal via an optical transmission and reception module, so that a game may be enjoyed in the mobile communications terminal.
